(19) United States
(12) Patent Application Publication
(10) Pub. No.: US 2018/0102650 A1
(43) Pub. Date: Apr. 12, 2018

(54) POWER SYSTEM RELIABILITY

(71) Applicant: Transocean Sedco Forex Ventures Limited, George Town Grand Cayman (KY)

(72) Inventors: Edward Bourgeau, Houston, TX (US); Yin Wu, Houston, TX (US)

(73) Assignee: Transocean Sedco Forex Ventures Limited, George Town Grand Cayman (KY)

(21) Appl. No.: 15/730,592

(22) Filed: Oct. 11, 2017

Related U.S. Application Data
(60) Provisional application No. 62/407,304, filed on Oct. 12, 2016.

(51) Int. Cl. H02J 3/14; H01H 9/54

(52) U.S. Cl. CPC H02J 3/14; H01H 9/54

(57) ABSTRACT

A power system may include autonomous breakers coupling generators to a main bus. The autonomous breakers may detect deviation of power parameters of the main bus from a predetermined range and couple generators to the main bus to bring the power parameters within the predetermined range. Autonomous breakers may further couple loads to the main bus and may adjust loads to bring the power parameters back within the predetermined range. Breakers may also check for faults in buses and within themselves before closing and coupling power system components to each other.

### CROSS REFERENCE TO RELATED PATENT APPLICATIONS

This application claims the benefit of priority of U.S. Provisional Patent Application No. 62/407,304 to Edward Bourgeau filed Oct. 12, 2016 and entitled “Power System Reliability,” which is hereby incorporated by reference.

### FIELD OF THE DISCLOSURE

The instant disclosure relates to reliability of power systems. More specifically, portions of this disclosure relate to breaker control in power systems.

### BACKGROUND

Resiliency is an important consideration in any power system, regardless of the application. The issues to which the power system must be resilient vary based on the application. For example, on an offshore drilling vessel, the power system should be made resilient to flooding, fires, blackouts in the power system, or faults on buses that carry power from generators to electrical devices throughout the vessel.

An electrical system on a vessel conventionally includes multiple generators in compartmentalized units that are separated against fire and flood. The compartmentalized units prevent damage from fire or flood to one unit from propagating to another compartmentalized unit. However, control systems for the power system are not located in the compartmentalized units. Further, the control system relies on information from each of the generators in each of the compartmentalized units to control the power system. For example, a control system can determine whether or not and when generators can couple to a main power distribution bus. Although the loss of a generator or a control system may not result in a loss of all generators or control systems, the generators and their control systems are unable to function independently and can suffer reduced performance or be further damaged due to incorrect decisions made by a control system.

A breaker coupled between a generator and a power bus can break the connection between the power bus and the generator based on commands from a control system. Each breaker is linked by signal cables to other breakers, and the status of each breaker is included in the logic of the control section of the breakers. Consequently, damage to a breaker in one compartment creates erroneous behavior in a breaker in another compartment. Thus, the overall resiliency of the power system is reduced. Each breaker may include logic that controls the breaker either in the same cabinet or external to the cabinet.

FIG. 1 is a schematic representation of a configuration of breakers 112, 114, 116 within a power system 100, such as in an offshore drilling vessel. The breakers 112, 114, 116 are coupled between a main electrical bus 102 and generators 122, 124, 126, respectively. Barriers 150 may be placed between the generators 122, 124, and 126 to isolate operation of the generators 122, 124, and 126 should a fire, flood, or other catastrophe occur. Communication links 113, 115 couple the breakers 112, 114, 116 to each other. The breakers 112, 114, 116 also share a control power cable 199 used to provide power to the breakers 112, 114, 116. The main bus 102 can be connected as a single conductor or broken into multiple segments by tie breaker master/slave sets 151, 152 and 153, 154. Communication links 156, 157 couple the tie breaker sets 151, 152 and 153, 154, respectively, to each other. The tie breaker master/slave sets 151, 152 and 153, 154 also share a control power cable 199 used to provide power to the tie breaker master/slave sets 151, 152 and 153, 154.

The generator breakers 112, 114, 116 communicate the status of the generators 122, 124, and 126 over the communication links 113, 115, 131. Logic within each of the breakers 112, 114, 116 is dependent upon the behavior of each of the other breakers 112, 114, 116. For example, if the breaker 112 is instructed to perform synchronization with the main bus 102, then the breaker 112 must first indicate to the breaker 114 not to perform synchronization, or vice versa. If breaker 114 indicates it is performing a synchronization, no other breaker can perform a synchronization even if such indication is faulty. Therefore, if a communication link 131, 132, 133 between the management system 130 and the generator breakers 112, 114, 116 fails or if the any breaker 112, 114, 116 itself fails, then access to the other healthy breakers is interrupted.

Additional communications links may be provided between the management system 130 and the breakers 112, 114, 116, respectively. However, the additional communications links increase complexity of the system 100 and the number of connections that must be made between barriers 150. Decisions to open and/or close the breakers 112, 114, and 116 may be made by the management system 130 based on input from bus sensing units 140, 143, 144 coupled to the main bus 102. Communication is required between bus sensing units 140, 143, 144 and the management system 130 and between generator breakers 112, 114, and 116. Communication is required between bus sensing units 140, 143 and the tie breakers 151, 152, and communication is required between bus sensing units 143, 144 and the tie breakers 153, 154. Successful operation of the tie breakers sets 151, 152 and 153, 154 require communications between the tie breaker master 151 and its slave 152 and between the tie breaker master 153 and its slave 154. These communications links increase complexity of the system 100, and the number of connections that must be made between barriers 150. Furthermore, an operator using a management system 130 can communicate only to the master breaker 151 or 153 of the tie breaker sets 151, 152 and 153, 154. Therefore, if a communication link 134, 135 between the management system 130 and the master breaker 151 or 153, respectively, fails or if the master breaker 112 itself fails, then access to the other breaker 152, 154 is interrupted.

Shortcomings mentioned here are only representative and are included simply to highlight that a need exists for improved power systems, particularly for autonomous breaker power systems. Embodiments described herein address certain shortcomings but not necessarily each and every one described here or known in the art. Furthermore, embodiments described herein may present other benefits than, and be used in other applications than, those of the shortcomings described above.

### SUMMARY

A power system may include multiple generators and loads coupled to a main bus. Each generator and each load may be coupled to the main bus by way of an autonomous breaker. Each breaker may monitor the main bus to determine if power parameters of the bus are within a predetermined range. If a deviation of a power parameter from the predetermined range is detected, each of the breakers may open or close and adjust the loads and/or generators to which it is coupled based on the detection of the deviation. Breakers may also monitor for faults in the buses and devices to which they are coupled, and within themselves, and may refrain from closing if faults are detected. Thus, multiple generators and/or loads may autonomously couple to a main bus to maintain one or more power parameters of the main bus within a predetermined range.

A power system, may include a first bus coupled to an AC generator and a main bus. A first breaker may couple the first bus to the main bus. An autonomous first controller may be coupled to the first breaker and the AC generator. The first controller may be further coupled to the main bus to detect deviations of one or more power parameters of the main bus from a predetermined range. When the first controller detects such a deviation, it may close the first breaker to couple the generator to the main bus. The first controller may also adjust a power output of the generator to bring the power parameter of the main bus within the predetermined range. The first controller may do so autonomously with no input from other controllers or breakers of the power system.

The first controller may also be configured to check for faults before coupling the generator to the main bus. For example, the first controller may determine that there are no faults on the first bus, that there are no faults on the main bus, and that there are not faults within the first breaker, prior to closing and coupling the first bus to the main bus.

The power system may further include a second bus coupled to a load. A second breaker may be coupled between the second bus and the main bus. A second controller may be coupled to the second breaker, the main bus, and the load. The second controller may also, like the first controller, detect a deviation of a power parameter of the first bus from within a predetermined range. When such a deviation is detected, the second controller may adjust the load to bring the power parameter of the main bus within the predetermined range. If the power parameter has deviated from the predetermined range by greater than a threshold value, the second controller may decouple the load from the main bus entirely. When the load is decoupled from the main bus, the second controller may also adjust the power output of a thruster of the load to maintain a voltage on a DC bus of the thruster within a predetermined range of voltages to prevent a shutdown of the thruster. After decoupling the load from the main bus, the second controller may monitor the main bus to determine that the power parameter has reentered the predetermined range. The second controller may then determine that there is no fault on the main bus, the second bus, or in the second breaker. Once an absence of faults is determined, the second controller may close the second breaker, coupling the load to the main bus.

An autonomous circuit breaker including a circuit breaker and a breaker controller coupled to the circuit breaker may monitor one or more physical characteristics of itself to determine its condition. The autonomous breaker may also monitor one or more characteristics of a bus coupled to the breaker. The controller may control the circuit breaker based on the one or more power parameters of the first bus coupled to the breaker. For example, if the autonomous circuit breaker detects a fault on the bus, it may refrain from closing and coupling any power system components to the bus. The breaker controller may prevent the circuit breaker from closing based on the monitored physical characteristics of the breaker. For example, the controller may detect that a breaker is wearing out and may not reopen if closed again. To prevent possible damage to the system in the event of breaker failure, the controller may simply prevent the breaker from closing and may, optionally, alert an operator that the breaker is in need of repair.

Various physical characteristics of a breaker may be monitored to determine a condition of the breaker. For example, a coil terminal voltage of a coil of the breaker, a temperature of the coil, or an inductance of the coil of the breaker may be monitored. Various timing aspects of breaker operation may also be monitored to determine a condition of the breaker. A period of time between the breaker controller issuing a command to open or close the circuit breaker and the circuit breaker issuing an indication that it is open or closed, a period of time between the breaker controller issuing a command to open or close the circuit breaker and an anvil of the circuit breaker beginning to move, and a duration and magnitude of a current being applied to the breaker compared to a speed with which the anvil reacts to the application of the current may be monitored. Additionally, a vibration caused by the breaker when the breaker is opened or closed, a humidity inside a housing of the breaker, a magnetic flux inside the housing of the breaker, an air pressure inside the housing of the breaker, and a light intensity inside the housing of the breaker may be monitored. The breaker controller may collect data with respect to the physical characteristics of the breaker and may analyze it over time, for example, by comparing the data to a profile of an ideal breaker. When the condition of the breaker deteriorates past a certain level, for example below a predetermined condition threshold, the controller may prevent the breaker from closing until the condition is remedied or the breaker is replaced. The predetermined condition threshold may be set at a level where the breaker will not close if it is more likely than not that the breaker will not be able to re-open. Thus, a breaker may monitor its condition and disable itself if its condition deteriorates beneath a predetermined threshold.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a schematic representation of a power distribution system on an offshore drilling vessel or standalone power plant.

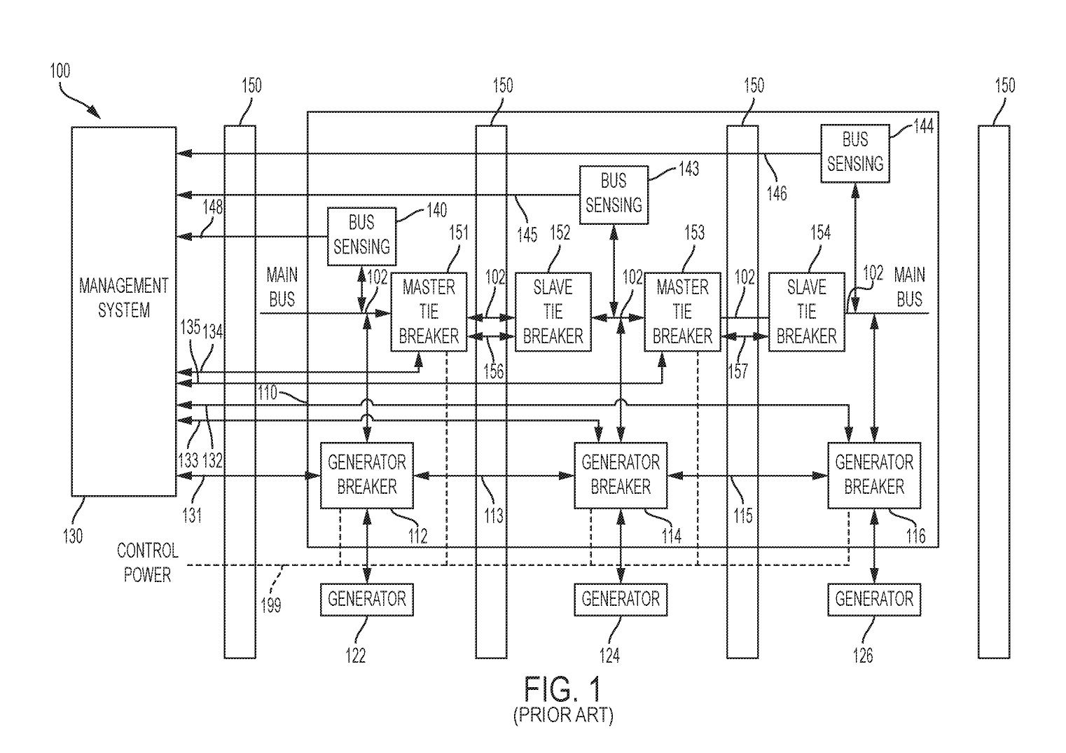

FIG. 2 is a schematic representation of a power system with independent breakers according to some embodiments of the disclosure.

FIG. 3 is a schematic representation of a breaker monitoring circuit according to some embodiments of the disclosure.

FIGS. 4A-C are a graphical illustration of example data collected by a breaker monitoring circuit according to some embodiments of the disclosure.

FIG. 5 is a schematic representation of a power system with independent breakers according to some embodiments of the disclosure.

FIG. 6 is a schematic representation of a power system with independent tie breakers according to some embodiments of the disclosure.

FIG. 7 is a schematic representation of a system for monitoring operation of a bus monitoring system according to some embodiments of the disclosure.

FIGS. 8A-B are a schematic representation of a ring power system with independent breakers and tie breakers according to some embodiments of the disclosure.

FIG. 9 is a flow chart illustrating an embodiment of a method for adjusting power applied to a bus to bring one or more power parameters of the bus within a predetermined range according to some embodiments of the disclosure.

FIG. 10 is a flow chart illustrating an embodiment of a method for determining bus health and adjusting power applied to a bus to bring one or more power parameters of the bus within a predetermined range according to some embodiments of the disclosure.

FIG. 11 is a flow chart illustrating an embodiment of a method for adjusting power drawn from a bus to bring one or more power parameters of the bus within a predetermined range according to some embodiments of the disclosure.

### DETAILED DESCRIPTION

Resiliency within a power system can be improved by reducing reliance of components on each other and enhancing monitoring of components. Reliance of components on each other can be reduced by limiting a component's reliance on communication with other components in determining its own operations and actions. For example, breakers can include logic that allows individual operation with little or no input from other breakers. Properties of a breaker such as current, voltage, timing, and other breaker properties, may be monitored, and the breaker can operate based, in part, on the monitored properties. Breakers that exhibit faults or are approaching failure may be disabled. Properties of buses coupled to a breaker and devices coupled to those buses may also be monitored, and the breaker may operate individually based on the bus and device properties to recover from errors in the power system. In some embodiments, breakers can operate autonomously without relying on data received from other breakers.

For example, a controller of a breaker may monitor various properties of buses coupled to the breaker and devices coupled to those buses. Power may be monitored on one or more buses coupled to a breaker and power generated by a generator coupled to one of the buses. The breaker may close if the controller detects a deviation of a power parameter of a main bus coupled to the breaker from a predetermined range. When closed, the breaker couples the generator to the main bus. The controller may also adjust power generated by the generator to bring the power parameter of the main bus within the predetermined range. Thus, controllers may autonomously operate breakers and associated power system components, such as generators and loads, to recover from power system errors.

A controller of a breaker may also monitor properties of the breaker, such as temperature, response time, humidity inside a breaker enclosure, motion that occurs when the breaker is opened or closed, and other breaker properties, and may control the breaker based in part on the monitored properties. For example, when monitored properties of a breaker indicate that a breaker is in poor condition and may not re-open if closed, the controller may prevent the breaker from closing and alert an operator that the breaker is in need of attention, such as repair or replacement.

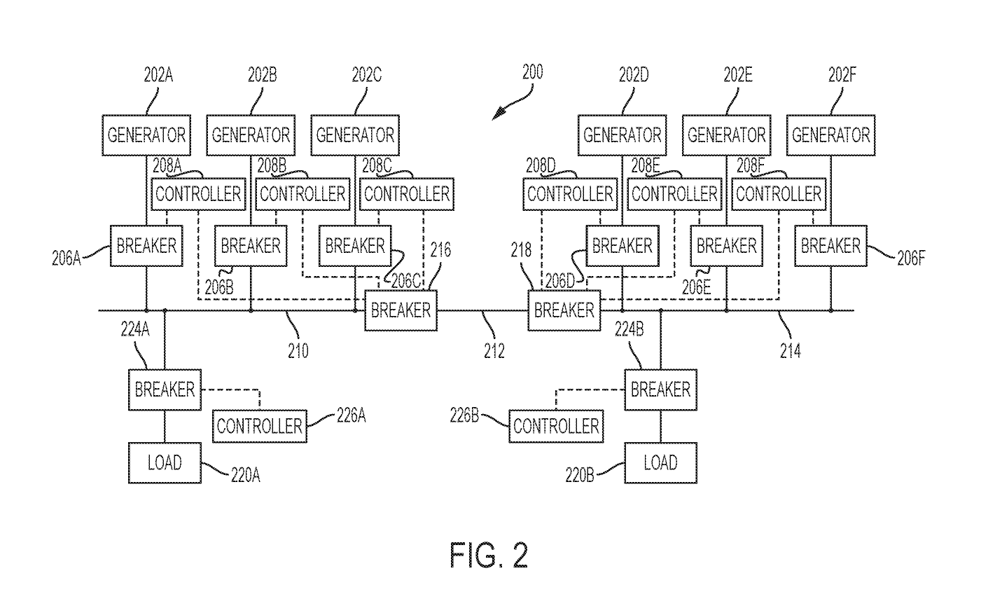

A power system may include multiple generators and loads that may operate individually to maintain operation of the power system within predetermined operating parameters. FIG. 2 is a schematic representation of a power system 200 including multiple generators 202A-F and loads 220A-B coupled to a main bus by an array of individually controlled breakers 206A-F and 224A-B. Generators 202A-F may be coupled to a main bus 210, 212, and 214, by breakers 206A-F, respectively. Each breaker 206A-F may be individually controlled by a controller 208A-F to couple the generators 202A-F to the main bus 210, 212, and 214, and to decouple the generators 202A-F from the main bus 210, 212, and 214. Each controller 208A-F may operate its breaker 206A-F autonomously, without a need for communication with the other controllers 208A-F, based on predefined strategies. For example, each controller 208A-F may independently execute a method using internal circuitry with little or no information from other controllers 208A-F or breakers 206A-F, to determine whether it is safe to close the breaker, whether the breaker will be able to reopen after closing the breaker, and/or to determine whether the main bus 210, 212, and 214 is within proper operating parameters, and to adjust generator output and couple the generators 202A-F to the main bus 210, 212, and 214 based on those determinations. If a breaker, such as breaker 206A, fails, the failure will not impair the operation of breakers 206B-F Likewise, if a controller, such as controller 208A, fails, the failure will not impair the operation of the other controllers 208B-F.

The main bus 210, 212, and 214 may be subdivided by tie breakers 216 and 218 into a first bus segment 210, a second bus segment 212, and a third bus segment 214. Additional breakers (not shown) may be used to create additional segments. The tie breakers 216 and 218 may be controlled by the controllers 206A-C and 206D-F of breakers 202A-C and 202D-F coupled to their buses 210 and 214, respectively, or may be controlled individually by their own controllers (not shown). Thus, the tie breakers 216 and 218 may operate independent of each other, thereby enhancing system resiliency.

Loads 220A-B may be further coupled to the main bus 210, 212, and 214 via individually controlled breakers 224A-B, respectively. Each breaker 224A-B may be individually controlled by a controller 226A-B, respectively, to open and close the breaker 224A-B and couple the loads 220A-B to and decouple the loads 220A-B from the main bus 210, 212, and 214. For example, controller 226A may operate breaker 224A autonomously without the need for communication with breaker 224B or controller 226B. If a breaker, such as breaker 224A or 224B, or a controller, such as controller 226A or 226B, fails, it will not impair operation of the other breaker and controller. For example, each controller 226A-B may independently execute a method using internal circuitry with little or no information from other controllers 226A-B or breakers 224A-B, to determine whether it is safe to close the breaker, whether the breaker will be able to reopen after closing the breaker, and/or to determine whether the main bus 210, 212, and 214 is within proper operating parameters, and to adjust and/or couple the loads 220A-B to or decouple the loads 220A-B from the main bus 210, 212, and 214 based on those determinations.

As described herein, “breakers” may include a generator breaker, such as breakers 206A-F between generators 202A-F and the main power bus 210, 212, and 214. “Breakers” may further include a load breaker, such as breakers 224A-B between loads 220A-B and the main power bus 210, 212, 214. “Breakers” may also include a tie breaker, such as breakers 216 and 218 between segments of the main bus 210, 212, and 214. Each of these breakers 202A-F, 216, and 218 may be controlled by an autonomous controller 208A-F. Furthermore, each breaker 202A-F, 216, 218, and 224A-B and controller 208A-F and 226A-B may be powered by a power source separate from generators 202A-F.

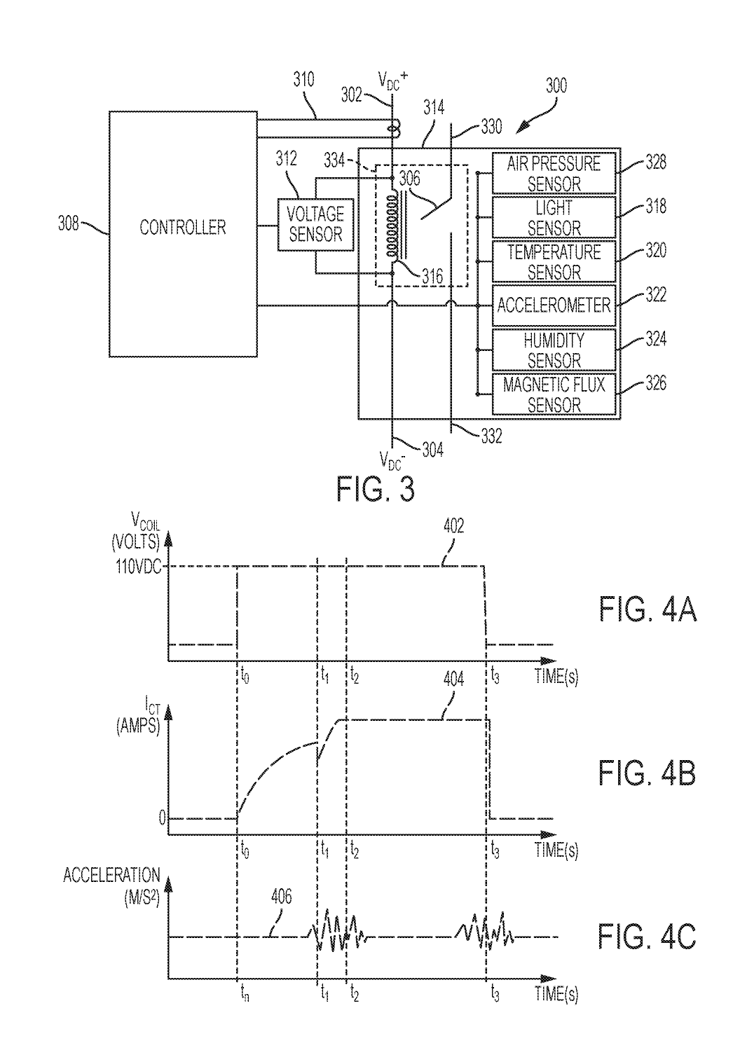

As breakers age and rotate through multiple couple and decouple cycles, they can experience wear and tear that may cause them to fail to respond to an instruction to open or close. To mitigate damage done by breakers that fail, a controller of a breaker may be equipped to monitor one or more properties of the breaker to determine a condition of the breaker. FIG. 3 is a schematic representation of a self-monitoring breaker 300. A breaker 334 may include a magnetic coil 316 and an anvil 306. When current is passed through the magnetic coil 316 the anvil 306 may be opened, or closed, to break or restore a coupling between a first bus 330 and a second bus 332. The coil 316 may be coupled between a first DC bus 302 and a second DC bus 304. The breaker 334 may be housed within a breaker housing 314. A controller 308 may be configured to monitor physical properties of the breaker 334. The controller 308 may be further configured to control the breaker 334 based, in part, on the physical properties of the breaker 334.

The controller 308 may be coupled to multiple sensors configured to monitor the various properties of the breaker 334. The controller 308 may be coupled to a voltage sensor 312 coupled to an input of the coil 316 and an output of the coil 316 to monitor a voltage across the coil 316. Such a measurement may be used by the controller 308 to detect changes in the coil 316 or a power supply to the coil 316 of the breaker 334. The controller 308 may be coupled to a current sensor 310 to measure a current through the coil 316 of the breaker 334. The controller 308 may use the voltage across the coil 316 and the current through the coil 316 to calculate a resistance of the coil 316. The resistance of the coil 316 may be used to calculate a temperature of the coil 316, which may be directly related to the resistance. An inductance of the coil 316 may also be calculated using data from the voltage sensor 312 and current sensor 310 by monitoring a rate of rise of the current through the coil 316 over time along with a voltage across the coil 316. The controller 308 may also measure a time between issuance of a command to open the breaker 334 and receipt of a signal from an auxiliary switch (not shown) indicating that the breaker 334 is open. The controller 308 may further measure a time between issuance of a command to open the breaker 334 and movement of an anvil 306 of the breaker 334, which causes a change in current flowing through the coil 316 of the breaker 334. The duration and magnitude of current being applied to the coil 316 may also be compared, by the controller 308, with movement of the anvil 306 in determining a condition of the breaker 334.

Several sensors may be located within the breaker housing 314. For example, a light sensor 318 may be located within a breaker housing 314 to measure a light intensity within the housing 314. The controller 308 may analyze data received from the light sensor 318 to detect a variety of conditions within a breaker housing 314 such as a door of the housing 314 being open, arcing, loss of lighting, and other lighting conditions. For example, the controller 308 may compare a picture obtained by the light sensor 318 with a picture of an interior of the housing 314 in proper working order to determine if there are any discrepancies.

A temperature sensor 320 may also be coupled to the controller 308 and located within the breaker housing 314 to measure an ambient temperature around the breaker 316. The controller 308 may compare the temperature data with a temperature profile to determine a condition of the breaker 334.

An accelerometer 322 may be coupled to the controller 308 and located within the breaker housing 314 to measure movement of the housing 314 caused by operation of the breaker 334. For example, when the breaker 334 is opened or closed, it may cause vibrations in the housing 314 that may be sensed by the accelerometer 322. The controller 308 may compare data received from the accelerometer 322 with timing of a command to open or close the breaker 334 to determine a time between when the command to close the breaker 334 is issued and when the breaker 334 is actually opened or closed. The controller 308 may compare the vibration and timing data with a profile of a healthy breaker to determine a condition of the breaker 314. Data with respect to magnitude, frequency, and phase of vibrations along a horizontal, a vertical, and a depth axis may be used in analyzing vibration of the housing 314. An amplitude and phase envelope of the vibration could be compared with an envelope of a healthy breaker. For example, if the vibration and timing data differ from the profile, they may indicate a cracked spring within the breaker 334 or other broken component.

A humidity sensor 324 may be coupled to the controller 308 and located within the breaker housing 314 to measure a humidity within the breaker housing. Data from the humidity sensor 324 can be used by the controller 308 to determine if there is excessive moisture within the housing 314 due to, for example, water leakage or problems with a ventilation system.

A magnetic flux sensor 326 may also be coupled to the controller 308 and located within the housing 314 to measure a magnetic flux within the housing 314. A rapid change in magnetic flux within the housing 314 may indicate a problem with the breaker 334.

An air pressure sensor 328 may also be coupled to the controller 308 and located within the housing 314. The controller 308 may use data received from the air pressure sensor 328 to detect changes in air pressure that may indicate problems with a ventilation system or an electrical short circuit which may cause a temporary spike in air pressure.

The controller 308 may compare data collected from sensors 310, 312, and 318-328 with a baseline profile of the breaker 334. Deviation of parameters, such as voltage, current, timing, humidity, light, movement, or magnetic flux, from the baseline profile may indicate that the breaker 334 is approaching failure. Alternatively or additionally, the controller 308 may compare data collected from sensors 318-328 with data collected from sensors of other breakers. Data collected by multiple controllers of multiple breakers may be aggregated and analyzed by a central controller to create an accurate historical breaker profile to more accurately predict breaker failure. When the controller 308 determines that the breaker 334 is approaching failure, the controller 308 may trigger an alert to inform an operator that the breaker requires maintenance and/or deactivate the breaker 334 to prevent it from closing. A controller separate from controller 308 may be used to control the breaker and may communicate with the controller 308 to determine a condition of the breaker 334. Alternatively, the controller 308 may both monitor and control the breaker 334.

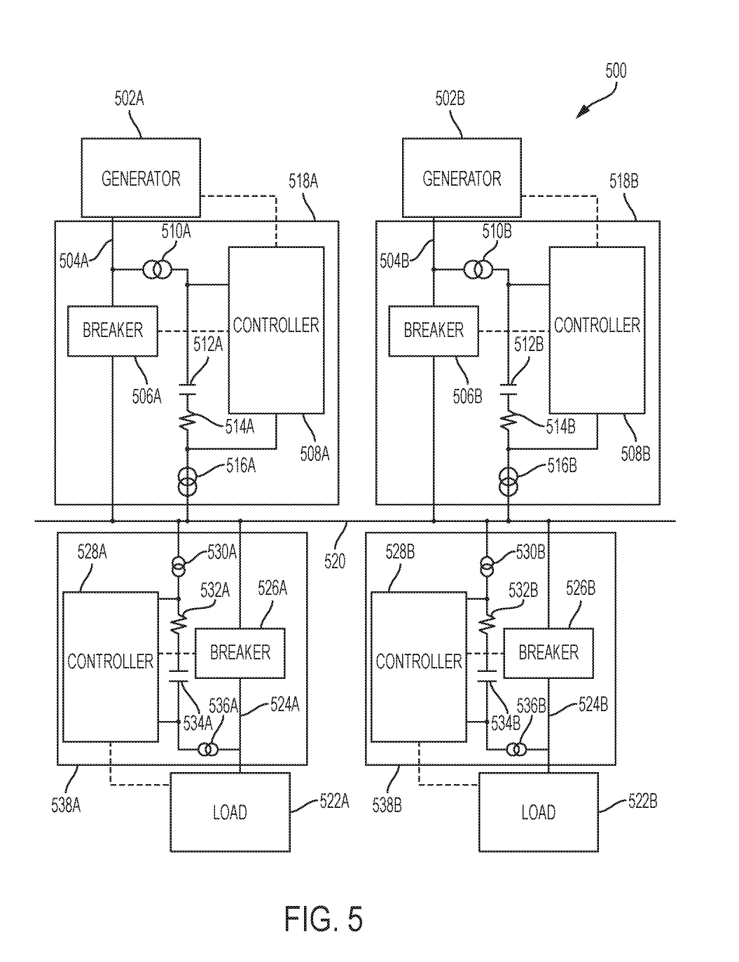

An example voltage profile is illustrated in FIG. 4A. Line 402 illustrates a voltage across a coil of a breaker with respect to time. A voltage measured by voltage sensor 312 over time may be compared against such a profile to determine if the breaker 334 is in working order. At time t0, a voltage is applied to the coil of the breaker to open the breaker. At time t3, the voltage is removed from the coil of the breaker to close the breaker.

An example current profile is illustrated in FIG. 4B. Line 404 illustrates current through a coil of a breaker with respect to time. A current measured by current sensor 310 over time may be compared against such a profile to determine if the breaker 334 is in working order. At time t0 a current begins to flow through the breaker. At time t1, a trip coil of the breaker may activate, causing a temporary drop in current. At time t2, the breaker may open, with current through the coil reaching a steady state. At time t3, the voltage and current being supplied to the breaker may be cut off to close the breaker.

An example acceleration profile is illustrated in FIG. 4C. Line 406 illustrates acceleration of a breaker with respect to time, as a breaker is opened and closed. Acceleration measured by accelerometer 322 over time may be compared against such a profile to determine if the breaker 334 is in working order. Prior to time t0, the breaker may begin to open causing the accelerometer to detect movement. Following time t2, the breaker may fully open causing the accelerometer to detect no more movement. Around time t3, the accelerometer may detect movement as the breaker closes, due to voltage and current across the coil being cut off. A magnetic flux density of the breaker over time may closely mirror the acceleration line 606, with a negative and positive magnetic field strength enveloping the line 406 as the line 406 increases and decreases when the breaker is opened and closed. Magnetic flux density may also be analyzed and compared against a profile to determine if the breaker 334 is in working order.

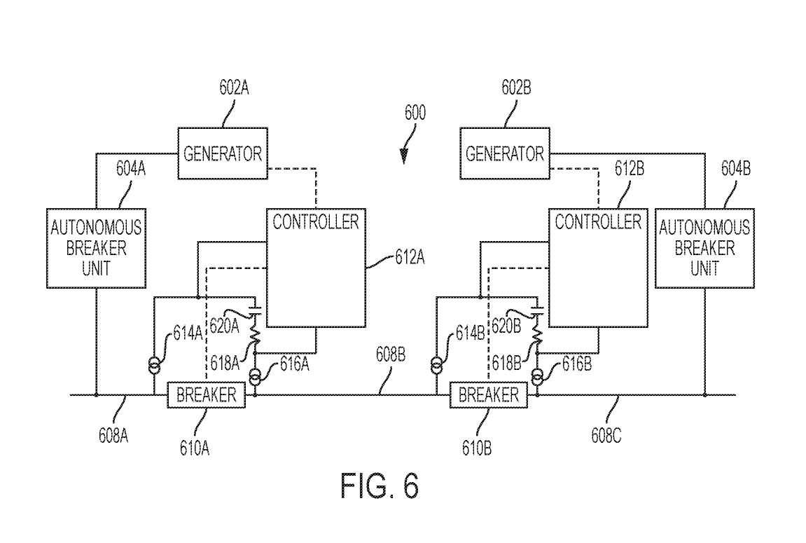

Breaker controllers may monitor power on a bus and may control breakers and loads or power sources coupled thereto based on the monitored power. For example, breaker controllers may detect faults on buses, such as a short circuit on the bus or a grounding failure, or deviation of power parameters from a predetermined range. Breaker controllers may also open and close breakers coupled to power sources and loads and adjust power sources and loads based on detected faults or power parameter deviations. FIG. 5 is an example schematic representation of a power system including multiple generators 502A-B and multiple loads 522A-B coupled to a main bus 520 via breakers 506A-B and 526A-B. Each generator 502A-B may be coupled to a breaker 506A-B via a generator bus 504A-B. Each generator bus 504A-B may be coupled to the main bus 520 via the breakers 506A-B, respectively. The breakers 506A-B coupling the generators 502A-B to the main bus 520 may be part of autonomous breaker units 518A-B along with controllers 508A-B to control the breakers 508A-B based on measurement of power parameters of and detection of faults on the main bus 520 and/or measurement of power parameters of and detection of faults on the generator buses 504A-B. The controllers 508A-B may be further configured to control the generators 502A-B based on measurement of power parameters of the main bus 520. The autonomous operation of each of controllers 508A-B may be individually configured based on the generator to which it is coupled.

The controllers 508A-B may measure one or more power parameters of the generator buses 504A-B through power transformers 510A-B. If the generator buses 504A-B are dead, the controllers 508A-B may test for faults on the buses 504A-B by applying a test signal to the generator buses 504A-B through power transformers 510A-B and recording responses of buses 504A-B to the test signal. For example, a bus response to a test signal may include a line-to-line impedance of the bus, a line-to-ground impedance of the bus, a voltage of power on the bus, and a phase angle of power on the bus. The response may be compared with an expected response of a healthy bus, to determine if the response is within a predetermined range of the healthy response. The test signal may be a low energy test signal supplied from a source other than generators 502A-B. If the buses 504A-B are live, the controllers 508A-B may sample various power parameters of the buses 504A-B, such as a frequency of power on the buses 504A-B, a voltage of power on the buses 504A-B, and/or a current of power on the buses 504A-B. If a fault is detected on a generator bus, the controller coupled to the breaker coupled to that bus will prevent the breaker from closing. For example, if a fault is detected on bus 504A, controller 508A will prevent breaker 506A from closing and coupling generator 502A to the main bus 520. If a controller detects that a power parameter of a generator bus has deviated from a predetermined range, the controller may adjust the operation of the generator to which it is coupled to bring the power parameter of the bus back within the predetermined range. For example, if controller 508A detects that a power parameter of bus 504A is outside of a predetermined range, controller 508A may adjust the operation of generator 502A to bring the power parameter of bus 504A back within the predetermined range.

The controllers 508A-B may also test the main bus 520 for faults and measure one or more power parameters of power transmitted on the main bus 520 through power transformers 516A-B. If the main bus 520 is dead, the controllers 508A-B may test for faults on the main bus 520 by applying a test signal to the main bus 520 through power transformers 516A-B and recording a response of the main bus 520 to the test signal. The response may be compared with an expected response of a healthy bus, to determine if the response is within a predetermined range of the healthy response. The test signal applied to the main bus 520 may be a low energy test signal supplied from a source other than generators 502A-B. If the main bus 520 is live, the controllers 508A-B may sample various power parameters of the main bus 520 such as a frequency of power on the main bus 520, a voltage of power on the main bus 520, and/or a current of power on the main bus 520. If a controller detects a fault on the main bus 520, the controller may prevent the breaker to which it is coupled from closing and coupling its generator to the main bus 520. For example, if controller 508A detects a fault on the main bus 520, it will prevent breaker 506A from closing and coupling generator 502A to the main bus 520. If multiple autonomous controllers check a bus for faults simultaneously, creating a low energy collision on the bus, the controllers will detect that the bus is faulty, and delay for a period of time before checking the bus again. Controllers of breakers for generators and loads may be further configured to distinguish between a voltage applied when checking for faults and a full voltage applied by a generator to power the main bus to avoid false positives when determining whether to connect to or disconnect from the main bus. Multiple autonomous generator breaker controllers of a power system may be on a staggered bus checking interval to avoid subsequent collisions. If a controller detects that a power parameter of the main bus 520 has deviated from a predetermined range, the controller may adjust the operation of the generator to which it is coupled and/or close the breaker to which it is coupled to supply additional power to the main bus 520 and bring the power parameter of the main bus 520 back within the predetermined range. For example, if controller 508A detects that a power parameter of the main bus 520 is outside of a predetermined range, it may close breaker 506A to couple generator 502A to the main bus 520 and adjust the operation of generator 502A to bring the power parameter of the main bus 520 back within the predetermined range. Multiple controllers coupled to generators that are not currently coupled to a main bus may autonomously close breakers between the generators and the main bus and adjust operation of the generators when they detect that one or more power parameters of power on the main bus have deviated from a predetermined range. Power transformers 510A-B coupled to the generator buses 504A-B may be coupled to power transformers 516A-B coupled to the main bus 520 via resistors 514A-B and capacitors 512A-B.

Each load 522A-B may be coupled to a breaker 526A-B via a load bus 524A-B. Each load bus 524A-B may be coupled to the main bus 520 via the breakers 526A-B. The breakers 526A-B coupling the loads 522A-B to the main bus 520 may be part of autonomous breaker units 538A-B along with controllers 528A-B to control the breakers 526A-B based on measurement of power parameters of and detection of faults on the main bus 520 and/or measurement of power parameters of and detection of faults on the load buses 524A-B. The controllers 528A-B may be further configured to control the loads 522A-B based on measurement of power parameters of the main bus 520. The autonomous operation of each of controllers 528A-B may be individually configured based on the load to which it is coupled.

The controllers 528A-B may measure one or more power parameters of the load buses 524A-B through power transformers 536A-B. If the load buses 524A-B are dead, the controllers 528A-B may test for faults on the buses 524A-B by applying a test signal to the load buses 524A-B through power transformers 536A-B and recording responses of buses 524A-B to the test signal. The responses may be compared with an expected response of a healthy bus, to determine if the responses are within a predetermined range of the healthy response. The test signal may be a low energy test signal supplied from a source other than generators 502A-B. If the buses 524A-B are live, the controllers 528A-B may sample various power parameters of the buses 524A-B, such as a frequency of power on the buses 524A-B, a voltage of power on the buses 524A-B, and/or a current of power on the buses 524A-B. If a fault is detected on a load bus, the controller coupled to the breaker coupled to that bus will prevent the breaker from closing. For example, if a fault is detected on bus 524A, controller 528A will prevent breaker 526A from closing and coupling load 522A to the main bus 520. If a controller detects that a power parameter of a load bus has deviated from a predetermined range, the controller may adjust the operation of the load to which it is coupled to bring the power parameter of the bus back within the predetermined range. For example, if controller 528A detects that a power parameter of bus 524A is outside of a predetermined range, it may adjust the operation of load 522A to bring the power parameter of bus 524A back within the predetermined range. For example, if load 522A is a thruster, the controller 528A may reduce the amount of power consumed by the thruster.

The controllers 528A-B may also test the main bus 520 for faults and measure one or more power parameters of power transmitted on the main bus 520 through power transformers 530A-B. If the main bus 520 is dead, the controllers 528A-B may test for faults on the main bus 520 by applying a test signal to the main bus 520 through power transformers 530A-B and recording a response of the main bus 520 to the test signal. The response may be compared with an expected response of a healthy bus, to determine if the response is within a predetermined range of the healthy response. The test signal applied to the main bus 520 may be a low energy test signal supplied from a source other than generators 502A-B. If the main bus 520 is live, the controllers 528A-B may sample various power parameters of the main bus 520 such as a frequency of power on the main bus 520, a voltage of power on the main bus 520, and/or a current of power on the main bus 520. If a controller detects a fault on the main bus 520, the controller may prevent the breaker to which it is coupled from closing and coupling its load to the main bus 520. For example, if controller 528A detects a fault on the main bus 520, it will prevent breaker 526A from closing and coupling load 522A to the main bus 520. If a controller detects that a power parameter of the main bus 520 has deviated from a predetermined range, the controller may adjust the operation of the load to which it is coupled and/or open the breaker to which it is coupled to decouple the load from the main bus 520 and bring the power parameter of the main bus 520 back within the predetermined range. For example, if controller 528A detects that a power parameter of the main bus 520 is outside of a predetermined range, it may adjust the operation of load 522A to reduce the power consumption of load 522A and bring the power parameter of the main bus 520 back within the predetermined range. If a power parameter of the main bus 520 is detected to have deviated from the predetermined range by greater than a threshold amount, controllers may open the breakers to which they are coupled to decouple their loads from the main bus 520. Multiple controllers coupled to loads may autonomously adjust power consumption of the loads and/or open breakers between the loads and the main bus when they detect that one or more power parameters of power on the main bus 520 have deviated from a predetermined range. Power transformers 536A-B coupled to the load buses 524A-B may be coupled to power transformers 530A-B coupled to the main bus 520 via resistors 532A-B and capacitors 534A-B. A plurality of generators and loads may operate autonomously to maintain one or more power parameters of a bus within a predetermined range and to decouple from or avoid coupling to a faulty bus.

A controller, such as controllers 508A-B, may also determine a health of the generator to which it is coupled, such as generators 502A-B. For example, controller 508A may run a math model in generator 502A, measuring the frequency and output power of the generator. The controller 508A may then analyze the frequency and output power to determine if the generator is healthy. If not, the controller 508A may prevent the generator 502A from activating, prevent the breaker 506A from closing, and/or alert an operator that the generator 502A is in need of maintenance.

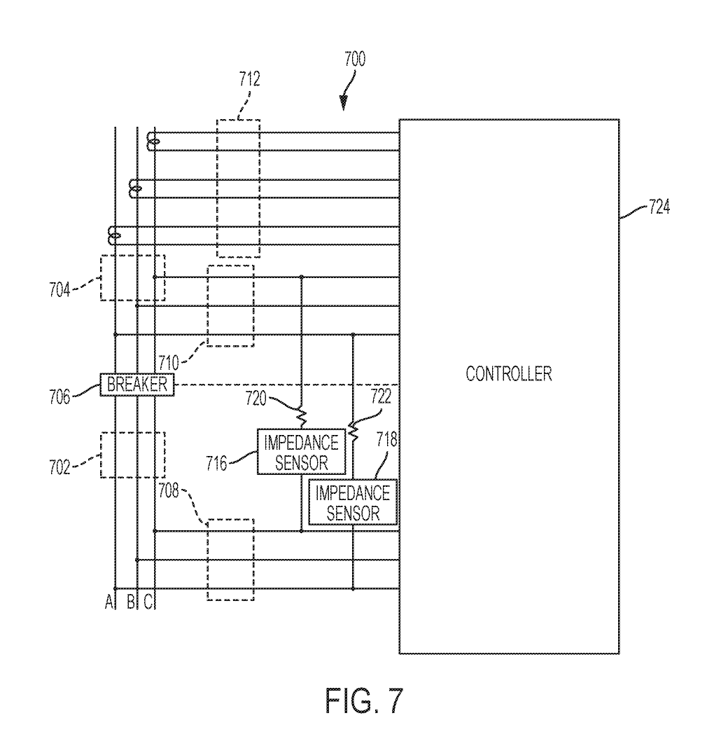

A main bus of a power system may be subdivided by autonomous tie breakers. Controllers of the tie breakers may sense for faults in the segments of the main bus before closing to couple the sections of the main bus together. Furthermore, controllers of tie breakers may be further coupled to generators coupled to segments to which they are coupled, and may control the generators based on power parameters detected on the main bus. FIG. 6 is an example schematic representation of a power system 600 including multiple tie breakers 610A-B for coupling multiple segments of a main bus 608A-C together. Segments of the main bus 608A-C may be coupled to generators 602A-B by way of autonomous breaker units 604A-B, as described with respect to FIG. 5. Each tie breaker 610A-B may be coupled to a controller 612A-B configured to test for faults on bus segments 608A-B and 608B-C, respectively, and/or to determine power parameters of power transmitted on the main bus 608A-C. Alternatively, tie breakers 610A-B may be controlled by controllers of autonomous breaker units 604A-B respectively, to maintain isolation between the subdivisions of the main bus 608A-C. The tie breakers 610A-B may be located on opposite sides of a bulkhead (not pictured) separating two segments of a power system, so that only the center bus 608B crosses the bulkhead.

Similar to the measurement of power parameters and detection of faults described with respect to the main bus and generator buses of FIG. 5, controllers 612A-B may detect faults and measure one or more power parameters of the segments of the main bus 608A-C. For example, controller 612A may detect faults on bus segments 608A-B by injecting test signals onto the main bus segments 608A-B through power transformers 614A and 616A, respectively. If faults are detected, controllers may prevent the tie breakers to which they are coupled from closing. For example, if controller 612A detects a fault on bus segment 608A or 608B, it may prevent breaker 610A from closing. If deviation of one or more power parameters from a predetermined range is detected, a controller may adjust operation of a generator to which it is coupled and/or control a breaker to which it is coupled based on that detection. For example, if controller 612A detects a deviation of a power parameter on bus 608B, it may adjust operation of generator 602A and close breaker 610A to couple generator 602A to bus 608B to bring the power parameter back within the predetermined range. Thus, generators coupled to bus segments may be autonomously coupled to additional bus segments when deviation of one or more power parameters from a predetermined range is detected on the additional bus segment, to bring power parameters of the additional bus segment back within the predetermined range. Tie breakers may also autonomously prevent coupling of two bus segments when a fault is detected on one or both of the bus segments.

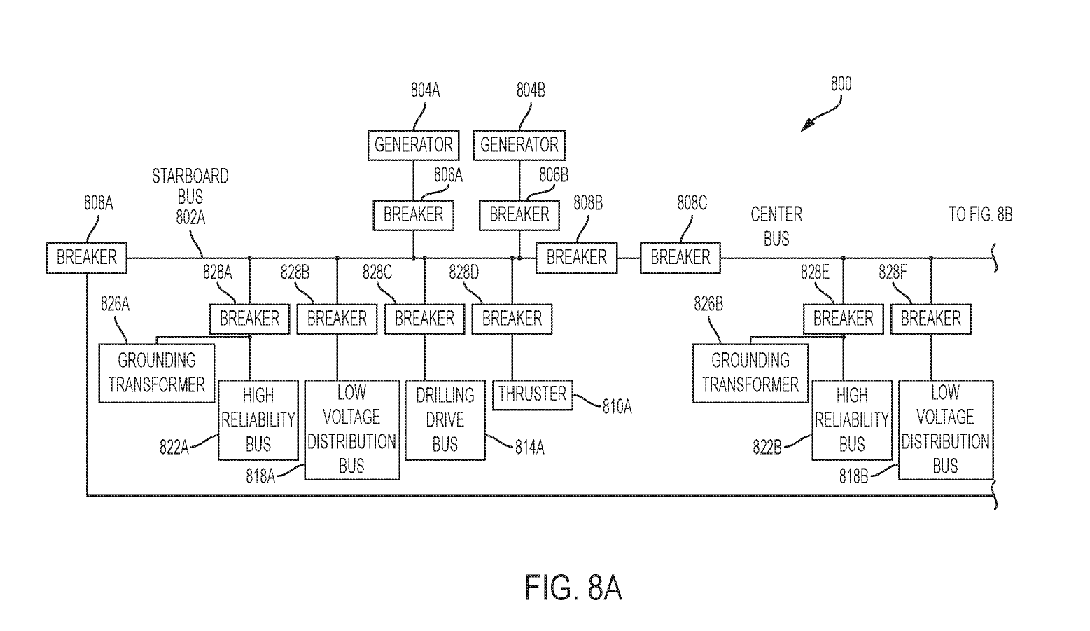

Circuitry for detecting faults on bus segments may also be tested for faults. FIG. 7 is an example schematic representation of a power system 700 with fault detection capability. A first three-phase bus 702 may be coupled to a second three-phase bus 704 via a breaker 706. A controller 724 may be configured to sample a voltage of each phase of the first three-phase bus 702 via a first trio of voltage sampling connections 708. The controller 724 may be further configured to sample a voltage of the second bus 704 via a second trio of voltage sampling connections 710. The controller 724 may be still further configured to sample a current of the second bus 704 via a trio of current sampling connections 712. In order to determine if there is a fault in either of the two sets of voltage sampling connections 708 and 710, a first phase of the first trio of voltage sampling connections 708 may be coupled to a first phase of the second trio of voltage sampling connections 710 via an impedance sensor 718 and a resistor 722. A third phase of the first trio of voltage sampling connections 708 may be coupled to a third phase of the second trio of voltage sampling connections 710 via an impedance sensor 716 and a resistor 720. The connection between the first phase of the first trio of voltage sampling connections 708 and the first phase of the second trio of voltage sampling connections 710 and the connection between the third phase of the first trio of voltage sampling connections 708 and the third phase of the second trio of voltage sampling connections 710 may create a consistent pattern in the sampled voltages of all three phases. If there is an error in a power transformer, voltage connector, or sampling bus of the voltage sampling circuitry, the pattern may deviate from the consistent form, allowing the controller 724 to detect a fault in the sampling circuitry. If a fault in sampling circuitry is detected, the controller 724 may prevent the breaker 706 from coupling the first bus 702 to the second bus 704. The connections between the first trio of voltage sampling connections 708 and the second trio of voltage sampling connections 710 can also allow the controller 724 to distinguish between a test signal applied to the first bus 702 or the second bus 704 and actual power transmission along one of the buses 702, 704.

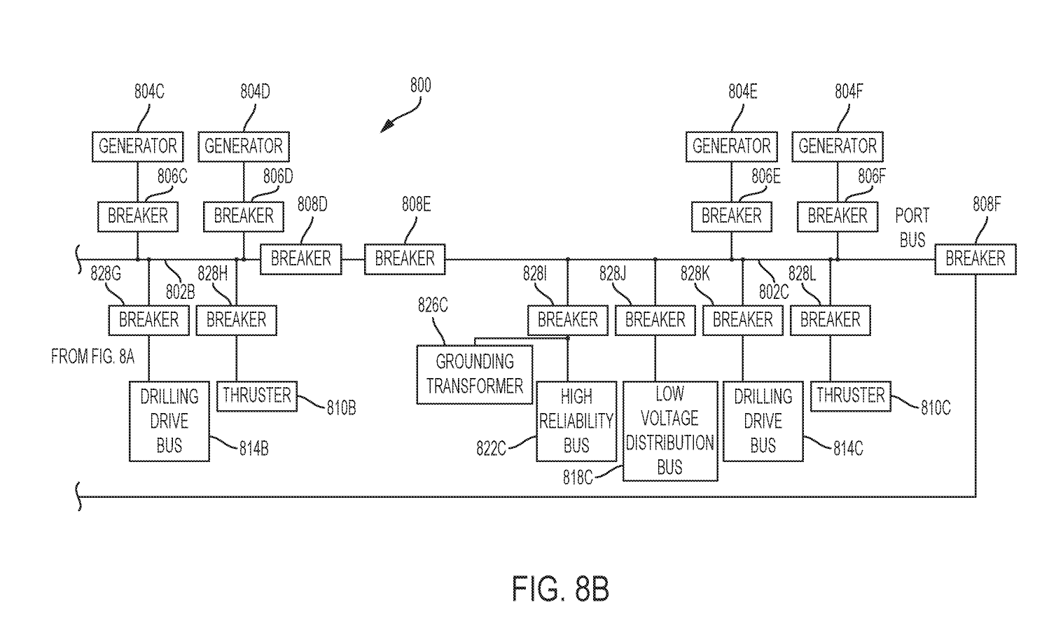

A power system may be arranged in a ring configuration to allow power transmission to remain uninterrupted even in the event of a failure of a single tie breaker. Multiple loads and generators may autonomously couple to and decouple from a main bus of the power system to improve power system reliability. Such loads and generators may be prevented from coupling to the main bus when faults are detected, either in the main bus or at the loads or generators. Further, additional generators may be brought online, the operation of generators already online may be adjusted, and loads coupled to the main bus may be adjusted and/or decoupled when a power parameter of power transmitted on the main bus deviates from a predetermined range, to bring the power parameter back within the predetermined range. If a power parameter deviates from a predetermined range for too long or by too great an amount a blackout may result, potentially causing damage to components of the system and reducing efficiency. FIGS. 8A-B are an example schematic representation of a power system 800. A main bus 802A-C of the power system 800 may be divided into a starboard bus 802A, a center bus 802B, and a port bus 802C. The starboard bus 802A may be coupled to the center bus 802B by a set of tie breakers 808B-C, the center bus 802B may be coupled to the starboard bus 802C by a set of tie breakers 808D-E, and the starboard bus 802C may be coupled to the port bus 802A by a set of tie breakers 808F and 808A. The tie breakers 808A-F may be autonomous tie breakers, and may be configured to determine whether faults exist on any of the buses 802A-C to which they are coupled. If a fault is detected, breakers may refrain from closing and coupling the buses together. The tie breakers 808A-F may be further configured to determine one or more power parameters of power transmitted on the buses to which they are coupled and may determine whether to open or close based on the determined power parameters. For example, if breaker 808C detects a deviation of a power parameter on center bus 802B from a predetermined range, breakers 808B-C may close, coupling the starboard bus to the center bus to bring the power parameter of the center bus back within the predetermined range. The ring configuration of power system 800 can allow for frequent testing of tie breakers 808A-F, as single sets of the breakers 808A-F can be opened and closed without affecting power distribution across the main bus 802A-C.

Multiple generators 804A-F may be coupled to the main bus 802A-C to provide power to multiple loads 810A-C, 814A-C, 818A-C, and 822A-C, also coupled to the main bus 802A-C. The generators 804A-F may each be coupled to the main bus 802A-C by means of autonomous breakers 806A-F. The autonomous breakers 806A-F may each individually determine whether there is a fault on the main bus 802A-C or on buses coupling the breakers 806A-F to the generators 804A-F. If a breaker detects a fault, it will not close, preventing coupling of a faulty generator or bus to an unfaulty generator or bus. The breakers 806A-F may also determine one or more power parameters of the main bus 802A-C. If a breaker detects a deviation of a power parameter, such as a voltage of the main bus 802A-C, a current of the main bus 802A-C, or a frequency of the main bus 802A-C, from a predetermined range, it may adjust operation of the generator to which it is coupled, for example, by increasing a power output. For example, if breaker 806A detects a deviation of a frequency of power on starboard bus 802A from a predetermined range, it may adjust a power output of generator 804A to bring the power parameter of the starboard bus 802A back within the predetermined range. If a breaker of a generator that is offline detects a deviation of a power parameter of the main bus 802A-C from a predetermined range, it may close, coupling its generator to the main bus 802A-C to bring the power parameter back within the predetermined range. For example, all tie breakers 808A-F may be closed and breakers 806A-B may also be closed so that generators 802A-B are supplying power to the main bus 802A-C. If a deviation of a power parameter of the main bus occurs, breakers 806A-B may each detect the deviation and adjust the operation of their respective generators 804A-B to bring the power parameter back within the predetermined range. Breakers 806C-F, which are open, may also each detect the deviation, and may close, coupling generators 804C-F to the main bus 802A-C to bring the power parameter back within the predetermined range. After the power parameter has been restored to the predetermined range, the breakers 806C-F may open, decoupling generators 804C-F from the main bus 802A-C or may remain closed. Thus breaker-generator pairs may operate as autonomous units to prevent coupling of faulty buses and generators and to maintain power parameters of a main bus within a predetermined range.

Loads 810A-C, 814A-C, 818A-C, and 822A-C may also be coupled to the main bus 802A-C via autonomous breakers 828A-L. Loads may, for example, include high reliability buses 822A-C, low voltage distribution buses 818A-C, drilling drive buses 814A-C, and thrusters 810A-C. Grounding transformers 826A-C may be coupled to the high reliability buses 822A-C. The autonomous breakers 828A-L may each individually determine whether there is a fault on the main bus 802A-C and whether there is a fault on the buses coupling the breakers 828A-L to the loads 810A-C, 814A-C, 818A-C, and 822A-C. If a fault is detected, each breaker that detects the fault will refrain from closing, preventing loads from being coupled to a faulty bus or a bus from being coupled to a faulty load. The breakers 828A-L may also determine one or more power parameters of the main bus 802A-C. If a breaker detects a deviation of a power parameter, such as a voltage of the main bus 802A-C, a current of the main bus 802A-C, or a frequency of the main bus 802A-C, from a predetermined range, it may adjust operation of the load to which it is coupled, for example, by reducing a load. For example, if breaker 828D detects a deviation of a frequency of power on starboard bus 802A from a predetermined range, it may adjust power consumption of thruster 810A to bring the power parameter of the starboard bus 802A back within the predetermined range. Other breakers, such as breaker 828A coupling the main bus 802A-C to a high reliability bus 822A may refrain from adjusting the load even when a deviation of a power parameter is detected. If a breaker detects that a power parameter of the main bus has deviated from a predetermined range by greater than a threshold amount, the breaker may open, decoupling the load from the main bus 802A-C entirely. The breaker may then monitor the main bus 802A-C, and when it detects that the power parameter has reentered the predetermined range, it may close, re-coupling the load to the main bus. Thus breaker-load pairs may operate as autonomous units to prevent coupling together of faulty buses and loads and to maintain power parameters of a main bus within a predetermined range.

The autonomous breakers 808A-F, 806A-F, and 828A-L may allow the power system 800 to autonomously recover following a blackout. The generators 804A-F may autonomously start and be coupled to the main bus 802A-C by breakers 806A-F. Each breaker may determine whether there is a fault on the generator or main bus side of the breaker prior to closing and coupling the generator to the main bus 802A-C. If there is a fault, the breaker may refrain from closing. As soon as power is provided to the main bus 802A-C, autonomous breakers 828A, 828E, and 8281 may close, bringing the high reliability buses 822A-C online, as long as they do not detect any faults. The high reliability buses 822A-C may provide power to devices such as lube oil pumps, fuel pumps, and other equipment necessary for maintenance of the generators 804A-F. Breakers 828B-D, 828F-H, and 828J-L may monitor the main bus to determine when the one or more power parameters of the main bus 802A-C have entered the predetermined range, before closing and coupling their loads to the main bus. Loads 810A-C, 814A-C, 818A-C, and 822A-C may have sufficient stored energy to prevent from complete shutdown during a blackout. Thus, sufficient power may be present to autonomously recouple when the system 800 recovers from the blackout. For example, thrusters 810A-C, when decoupled from the main bus 802A-C may convert energy stored in the rotating mass of the thruster to DC energy, which, along with other stored energy, may be sufficient to allow the thruster to remain activated and recouple to the main bus 802A-C without auxiliary power. Thus, all thrusters 810A-C may recouple to the main bus 802A-C simultaneously with little impact on the main bus 802A-C because they are already active and do not need extra power to engage in a startup sequence. In some embodiments drilling equipment, such as equipment coupled to drilling drive buses 814A-C, for example a draw works, may be decoupled from the power system 800 by a bank of ultra-capacitor energy storage units, to allow operation even when a blackout occurs.

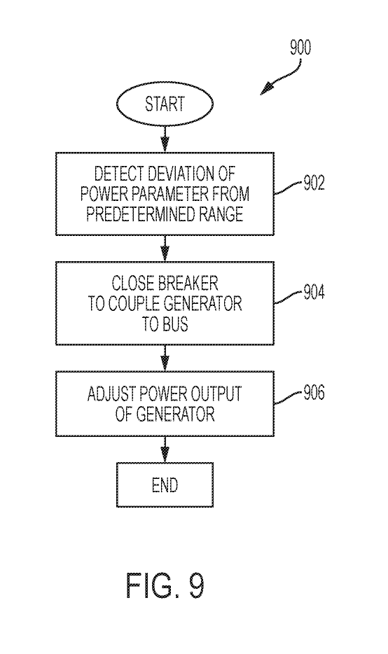

A power system may include multiple breakers capable of operating autonomously to detect deviations of power parameters on a bus from a predetermined operating range and coupling generators to that bus in order to bring the power parameters of the bus back within the predetermined range. FIG. 9 is an illustration of an example method 900 for detecting a deviation of a power parameter of a bus from a predetermined range and coupling a generator to the bus to bring the power parameter back within the predetermined range. The method may begin, at step 902, with detection of a deviation of a power parameter from a predetermined range. For example, an autonomous breaker, or a component of an autonomous breaker unit such as a breaker controller, may detect a deviation of a power parameter of a bus, such as a voltage, current, or frequency of power on the bus from a predetermined range. A breaker coupled between a generator and a main bus of a power system may detect such a deviation on the main bus.

When a deviation of a power parameter from a predetermined range has been detected, at step 902, the breaker may close, at step 904, coupling a generator to the bus. For example, the bus may have one or more generators already coupled thereto, but when a deviation of a power parameter from the predetermined range is detected, one or more additional generators may be coupled to the bus to bring the power parameter back within the predetermined range. Multiple breakers coupled to multiple generators may each autonomously detect the deviation of the power parameter from the predetermined range, at step 902, and may couple their generators to the bus, at step 904. Breakers may autonomously couple generators to the bus based on their own detection of a deviation of a power parameter on the bus and not on communication with other breakers or generators.

An operating parameter of the generator may also be adjusted, at step 906. For example, the breaker may adjust the operating parameter of the generator before or after closing and coupling the generator to the bus on which the power parameter had deviated from the predetermined range. The operating parameter may, for example, be a power output of the generator or a characteristic of a power output such as a frequency, voltage, or current of power output from the generator. Once the power parameter of the bus has returned to the predetermined range, the breaker may further adjust an operating parameter of the generator to maintain one or more power parameters of the bus within the predetermined range.

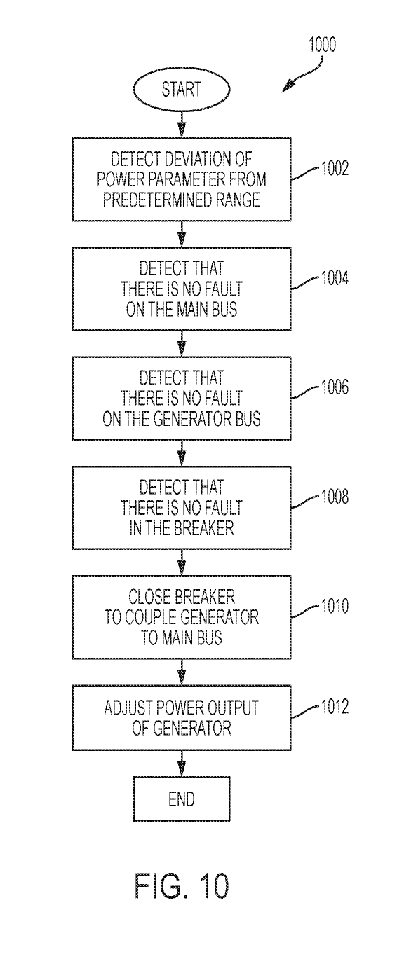

To avoid coupling faulty generators to a bus, breakers may also determine whether faults exist on buses to which they are coupled before coupling generators to a bus to bring a power parameter of the bus within a predetermined range. A method 1000 for determining whether faults exist on buses before coupling them together to bring a power parameter of a bus back within a predetermined range is illustrated in FIG. 10. The method 1000 may begin with detection of a deviation of a power parameter from a predetermined range, at step 1002, as described with respect to step 902 of FIG. 9.

A fault detection procedure may then begin, prior to closing the breaker, to determine whether there are faults. At step 1004, the method 1000 may proceed with detecting that there are no faults on the main bus. For example, an autonomous breaker may be coupled between a generator bus, coupled to a generator, and a main bus, coupled to one or more loads. The breaker, or, more specifically, a controller of the breaker, may determine that there are no faults on the main bus coupling the breaker to one or more loads. For example, the breaker may sample one or more power parameters of power on the main bus to determine whether there is a fault on the generator bus. Alternatively or additionally, a test signal may be applied to the main bus and sample a response of the main bus may be collected by the breaker and analyzed to determine that there are no faults on the main bus. The test signal may be generated using an alternate power source, other than the generator coupled to the generator bus. If a fault is detected on the main bus, the breaker may refrain from closing and coupling the generator to a faulty bus.

At step 1006, the method 1000 may proceed with detecting that there are no faults on the generator bus. For example, the breaker may determine that there are no faults on the generator bus by sampling one or more power parameters of power on the generator bus. Alternatively or additionally, the breaker may apply a test signal to the generator bus and a response of the generator to the test signal may be collected and analyzed to determine that there are no faults on the generator bus. The test signal may be generated using an alternate power source, other than the generator coupled to the generator bus. If a fault is detected on the generator bus, the breaker may refrain from closing and coupling the faulty generator bus to the main bus.

At step 1008, the method 1000 may proceed with detecting that there are no faults in the breaker. For example, an autonomous breaker may monitor various properties of itself as described above with respect to FIG. 3. The breaker, or more specifically a controller of the breaker, may analyze the monitored properties to determine that the breaker will be able to reopen after it is closed. If a fault is detected in the breaker, for example, if the breaker detects a breaker condition that may prevent it from reopening after it is closed, the breaker may refrain from closing and coupling the generator to the main bus. The autonomous breaker may further alert an operator that the breaker is in need of repair or replacement, if the breaker is not in a condition to be closed.

After determining that there are no faults in the main bus, the generator bus, and the breaker, the breaker may be closed, at step 1010 to couple the generator to the main bus, as described with respect to step 904 of FIG. 9. The power output of the generator may also be adjusted, at step 1012, as described with respect to step 906 of FIG. 9. Thus, breakers may check themselves and the buses to which they are coupled for faults before closing and coupling generators to the main bus.

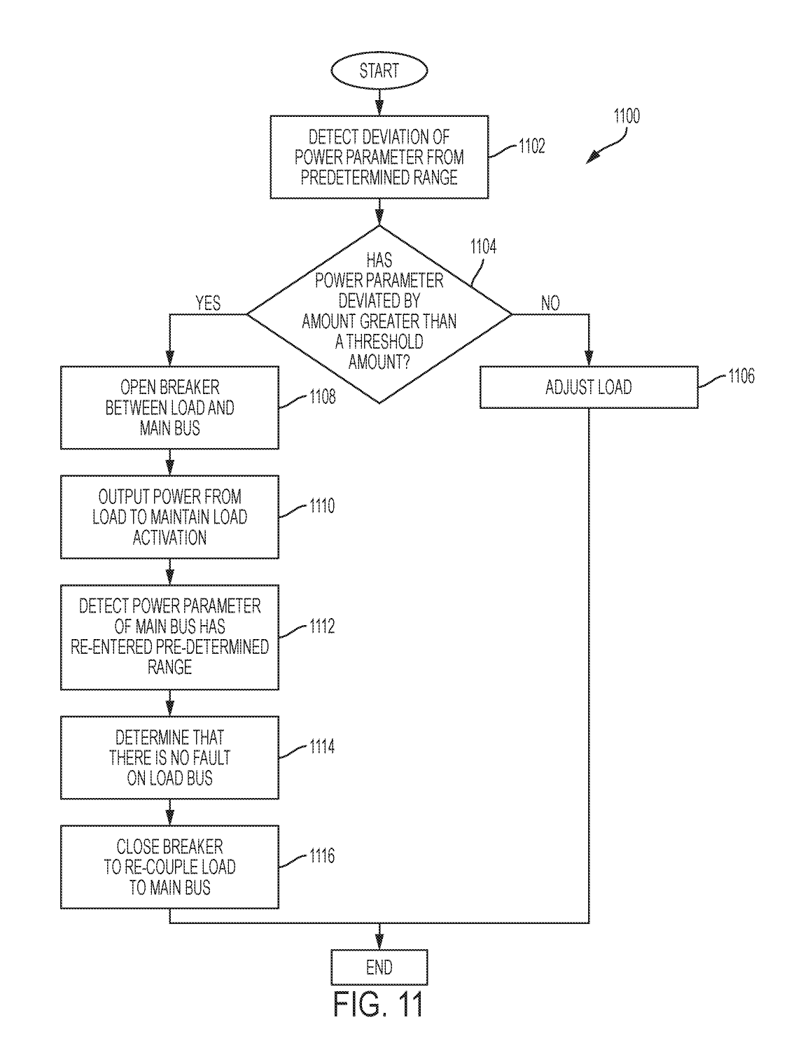

Breakers coupling loads to a main bus may also monitor for deviation of power parameters of the main bus from a predetermined range and adjust operation of the loads and/or decouple loads from the main bus entirely, in response to detecting such a deviation. FIG. 11 is an illustration of an example method for adjusting the loads and/or decoupling the loads from the main bus in response to a detection of a deviation of a power parameter of the main bus from a predetermined range. The method 1100 may begin at step 1102 with detection of a deviation of a power parameter from a predetermined range. For example, a breaker coupling a load to a main bus may detect a deviation of a power parameter of the main bus from within a predetermined range. If a breaker between the load and the main bus is open, the breaker will simply remain open and refrain from coupling the load to the main bus until the power parameter has returned to the predetermined range. However, if the breaker is closed, and the load is coupled to the main bus, the breaker may autonomously take corrective action to bring the power parameter of the main bus back within the predetermined range.

At step 1104, a determination may be made of whether the power parameter has deviated from the predetermined range by greater than a threshold amount. For example, a determination may be made of whether a frequency of power on the main bus has exceeded an upper limit of the predetermined range or fallen below a lower limit of the predetermined range by greater than a set amount.

If the power parameter is outside the predetermined range, but not by an amount greater than the threshold amount, the load may be adjusted, at step 1106, to bring the power parameter of the main bus back within the predetermined range. For example, power consumption of a thruster coupled to the breaker may be reduced. Alternatively, nonessential load items coupled to the breaker may be shut down. Some autonomous breakers, such as breakers coupled to high reliability buses, may be configured to avoid adjusting loads coupled thereto, even when a deviation of a power parameter from a predetermined range is detected.

If it is determined at step 1104 that the power parameter has deviated from the predetermined range by greater than the threshold amount, a breaker between the load and the main bus may be opened, at step 1108, decoupling the load from the main bus. For example, if a load on the main bus is too heavy for the main bus to maintain, given the deviation of the power parameter from the predetermined range, the breaker coupling the load to the main bus may autonomously decouple the load from the main bus.

In some cases, it may be advantageous to maintain load activation even when the load is decoupled from the main bus. A deviation of the power parameter may be temporary, and maintaining load activation may avoid a complicated and time-consuming start-up process. Therefore, if the breaker is opened and the load is decoupled from the main bus, at step 1108, the load may output power to its own bus at step 1110 to maintain activation. For example, if a thruster is decoupled from the main bus, it may convert power stored in the form of rotational energy in the thruster to DC energy to maintain power on a DC bus of the thruster and activation of the thruster. Thus the thruster can avoid a complete shutdown. Alternatively, the load may draw power from a power storage device coupled to its bus to maintain activation.

At step 1112, the power parameter of the main bus may be detected reentering the predetermined range. For example, generators coupled to the bus via autonomous breakers along with loads decoupled from the bus by autonomous breakers may bring the power parameter of the main bus back within the predetermined range and the breaker between the load and the main bus may detect that the power parameter has reentered the predetermined range. Such detection may also include the breaker determining that there is no fault on the main bus.

Prior to coupling the load to the main bus the breaker may determine that there is no fault on the load bus at step 1114, as described with respect to the generator bus in step 1006 of FIG. 10. If the load is a thruster, for example, the breaker may analyze various performance factors of the thruster such as a power consumption of the thruster to make sure that the thruster itself is in working order. If the load is a low voltage distribution bus, the breaker may determine that a transformer coupled between the breaker and the main bus is in working order and that a voltage on the breaker side of the transformer is at an appropriate level and synchronized with the main bus prior to closing. The response may be compared with an expected response of a healthy bus, to determine if the response is within a predetermined range of the healthy response. The breaker may further determine that there are no faults in the breaker prior to closing, as described with respect to the breaker in step 1008 of FIG. 10. When the power parameter has reentered the predetermined range, the breaker may autonomously close, at step 1116, coupling the load to the main bus. Loads may be adjusted to maintain one or more power parameters of a main bus within a predetermined range by autonomous breakers coupling the loads to the main bus.

The embodiments described herein may be incorporated in a power plant of a vessel, such as an offshore drilling vessel. Autonomous breakers may operate to isolate any faults within the power plant to prevent a blackout and may further verify lack of faults within themselves. For example, breakers in a power plant may monitor one or more parameters of a main bus, such as a voltage or current of the main bus of the power plant, for a departure of one or more parameters from a predetermined range and may adjust generators and/or loads by coupling them to and decoupling them from the main bus, and by adjusting operating parameters of the generators and/or loads already coupled to the main bus, to bring the voltage or current of the bus back within the predetermined range. If a blackout occurs, the breakers can autonomously bring generators and loads back online, while determining that there are no faults on the main bus, to prevent coupling generators or loads to a fault bus. Thus confidence in a power plant of a drilling vessel can be enhanced through use of autonomous breakers.

The schematic flow chart diagram of FIGS. 9-11 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An apparatus, comprising:
a first bus;
an AC generator coupled to the first bus;
a main bus;
a first breaker coupled between the first bus and the main bus; and
a first controller coupled to the first breaker and the AC generator;
wherein the first controller is configured to perform steps comprising:
detecting a deviation of a power parameter of the main bus from a predetermined range;
closing the first breaker to couple the first bus to the main bus; and
adjusting a power output of the generator to bring the power parameter of the main bus within the predetermined range.

2. The apparatus of claim 1, further comprising:
a second bus;
a load coupled to the second bus;
a second breaker coupled between the second bus and the main bus;
a second controller coupled to the second breaker and the load;
wherein the second controller is configured to perform steps comprising:
detecting the deviation of the power parameter of the main bus from the predetermined range; and
adjusting the load to bring the power parameter of the main bus within the predetermined range.

3. The apparatus of claim 2, wherein the step of detecting, performed by the second controller, comprises detecting that the power parameter of the main bus has deviated from the predetermined range of acceptable values by at least a threshold value, and wherein the step of adjusting the load comprises opening the second breaker to decouple the second bus from the main bus.

4. The apparatus of claim 2, wherein the second controller is further configured to perform steps comprising:
detecting that there is no fault on the second bus; and
closing the second breaker after detecting that there is no fault on the second bus.

5. The apparatus of claim 1, wherein the first controller is further configured to perform steps comprising detecting that there is no fault on the first bus prior to closing the first breaker.

6. The apparatus of claim 1, wherein the first controller is further configured to perform steps comprising detecting that there is no fault on the main bus prior to closing the first breaker.

7. The apparatus of claim 1, wherein the first controller is further configured to perform steps comprising detecting that there is no fault in the first breaker, prior to closing the first breaker.

8. The apparatus of claim 1, wherein the power parameter comprises a frequency of power on the main bus.

9. A method, comprising:
detecting, by a first controller, a deviation of a power parameter of a main bus from a predetermined range;
closing, by the first controller, a first breaker coupled between a first bus coupled to a generator and the main bus to couple the first bus to the main bus; and
adjusting, by the first controller, a power output of the generator to bring the power parameter of the main bus within the predetermined range.

10. The method of claim 9, further comprising:
detecting, by a second controller, the deviation of the power parameter of the main bus from the predetermined range; and
adjusting a load coupled to a second bus, the second bus being coupled to the main bus via a second breaker, to bring the power parameter of the main bus within the predetermined range.

11. The method of claim 10, wherein the step of detecting, performed by the second controller, comprises detecting that the power parameter of the main bus has deviated from the predetermined range by at least a threshold value, and wherein the step of adjusting the load comprises opening the second breaker to decouple the second bus from the main bus.

12. The method of claim 11, further comprising adjusting a power output of a thruster of the load to maintain a voltage on a DC bus of the thruster within a predetermined range of voltages to prevent a shutdown of the thruster, after opening the second breaker.

13. The method of claim 10, further comprising
detecting, by the second controller, that there is no fault on the second bus; and
closing the second breaker, by the second controller after detecting that there is no fault on the second bus.

14. The method of claim 9, further comprising detecting, by the first controller, that there is no fault on the first bus prior to closing the first breaker.

15. The method of claim 9, further comprising detecting, by the first controller, that there is no fault on the main bus prior to closing the first breaker.

16. The method of claim 9, further comprising detecting, by the first controller, that there is no fault in the first breaker, prior to closing the first breaker.

17. An circuit breaker, comprising:
a circuit breaker; and
a breaker controller coupled to the circuit breaker configured to monitor one or more physical characteristics of the breaker to determine a condition of a breaker.

18. The circuit breaker of claim 17, wherein the breaker controller is further configured to monitor one or more power parameters of a first bus coupled to the breaker.

19. The circuit breaker of claim 17, wherein the breaker controller is further configured to prevent the breaker from closing if it detects that a condition of the breaker is below a predetermined condition threshold.

20. The circuit breaker of claim 17, wherein the one or more physical characteristics of the breaker comprises at least one of:
a coil terminal voltage of a coil of the breaker;
a temperature of the coil;
an inductance of the coil;
a period of time between the breaker controller issuing a command to open or close the circuit breaker and the circuit breaker issuing an indication that it is open or closed;
a period of time between the breaker controller issuing a command to open the circuit breaker and an anvil of the circuit breaker beginning to move;
a duration and magnitude of a current being applied to the breaker compared to a speed with which the anvil reacts to the application of the current;
a vibration caused by the breaker when the breaker is opened or closed;
a humidity inside a housing of the breaker;
a magnetic flux inside the housing of the breaker;
an air pressure inside the housing of the breaker; and
a light intensity inside the housing of the breaker.
